(19) United States
(12) Patent Application Publication
(10) Pub. No.: US 2005/0003787 A1
(43) Pub. Date: Jan. 6, 2005

(54) Method and device for compensating voltage-controlled crystal oscillator of mobile unit

(75) Inventor: Liang-Fang Chen, Tainan City (TW)

Correspondence Address: Ladas & Parry, 26 West 61st Street, New York, NY, 10023, US

(73) Assignee: Benq Corporation

(21) Appl. No.: 10/862,852

(22) Filed: Jun. 7, 2004

(30) Foreign Application Priority Data
Jul. 1, 2003 (TW) 92117997

(51) Int. Cl. H04B 7/00; H04B 1/18

(52) U.S. Cl. 455/264; 455/151.3; 455/151.1

(57) ABSTRACT

A method for compensating voltage-controlled crystal oscillator of a mobile unit is firstly to define a pre-compensated value according to a voltage drop of an auto frequency control voltage while proceeding signal transmission between the mobile unit and a base station at different power levels so as to get specific pre-compensated values at corresponding power levels. Then, the method proceeds a compensating procedure to the voltage-controlled crystal oscillator with the pre-compensated value while transmitting Tx burst from the mobile unit to the base station so that a frequency of Tx burst can be regulated with respect to a frequency of Rx burst.

### BACKGROUND OF THE INVENTION

(1) Field of the Invention

The invention relates to a mobile unit, and more particularly to a compensation method and a corresponding device within the mobile unit which utilize voltage signals to compensate a voltage-controlled crystal oscillator inside the mobile unit.

(2) Description of the Prior Art

With recent developments in semiconductor industry and digital signal processing (DSP) technologies, communication technology has made a giant step closer toward the future world. In the communication technology, mobile communication gradually plays an important part for us in modem life. It is interesting to note that, averagely, each person in Taiwan holds more than one mobile phone. An immediate benefit from having a mobile phone is that the holder can reach out to a far-end party via such a wireless communication everywhere and any time. Definitely upon such a situation, the quality of the mobile-phone communication becomes a major concern in this field of communication.

As shown in FIG. 1, a diagram of communication between a mobile phone 10 and a base station 12 is shown. In the diagram, the mobile phone 10 receives a communication link from the base station 12 and a control center (not shown in the figure). Further, the base station 12 is controlled by a base station controller (also not shown in the drawing) which provides operating functions (such as handoff, intensity adjustment of output power level, channel management, and so on) between the base station 12 and the mobile phone 10. Before a communication in between begins, either calling or receiving, the base station 12 generates an initial communication in advance to the mobile phone 10. Then according to the signal intensity between the base station 12 and the mobile phone 10, the base station 12 will create a signal to inform the mobile phone 10 which power level and channel frequency should be adopted. Afterward, the mobile phone 10 can reply a Tx burst to communicate the base station 12. The foregoing description can explain the power control in a typical mobile communication system. Further, it is noted that the mobile phone can depend on transmission distance to adjust signal intensity to economize power consumption.

Referring to FIG. 2, a block diagram for generating a transmission frequency within a conventional mobile phone. As shown, a voltage-controlled crystal oscillator (VCXO) 241 is used to generate an oscillation frequency for an oscillation circuit 24. Also, a digital signal processor (DSP) 20, a DAC (D/A converter) 22 and a frequency synchronization circuit 26 are included this mobile phone system. When the mobile phone 10 replies a Tx burst (belongs to radio frequencies) in response to a frequency of transmission channel designated by an Rx burst coming from base station 12, a transmitted radio frequency is then generated from a base-band frequency generated by the VCXO 241 and the frequency synchronization circuit 26.

In this design of FIG. 2, a crystal within the VCXO 241 is utilized to sense static and dynamic errors and forward to the oscillation circuit 24. The static errors mainly come from initial crystal offsets, which may be given as a respective accuracy range at a designated temperature (25° C. typical). For the VCXO 241, the static errors must be measured and controlled in production for it can't be calibrated explicitly out of the oscillation circuit 24. Dynamic errors include temperature drifts, Doppler shifts and aging. As the temperature rises or falls, the crystal can expand accordingly which increases or decreases respectively a resonance frequency of the crystal. Frequency shifts caused by Doppler effects depend on the concurrent velocity of the mobile phone while communicating to the base station. Aging refers to frequency errors of the crystal after a substantial period of usage (typically, +/−2 ppm per year). Also, the digital signal processor 20 programs an auto frequency control (AFC) voltage to continuously adjust frequency errors by judging dynamic errors caused by the temperature drift, the Doppler effects and the aging.

Actually, the AFC voltage will decrease for a certain mount of value while the Tx burst is ramping up, because the power amplifier inside the mobile phone 10 will draw a lot of current from LDO (low-dropout regulators) and generate specific voltage drop which is dependent on the output power level. This voltage drop will directly affect a reference clock of the mobile phone 10, induce frequency errors, and more seriously result in unexpected drop call. Therefore, a compensation method that can regulate the frequency of Tx burst from the mobile phone to match the predetermined frequency of Rx burst from the base station is definitely welcome to the skilled in the art.

### SUMMARY OF THE INVENTION

Accordingly, it is one object of the present invention to provide a design of a mobile unit.

It is another object of the present invention to provide a method for establishing a database, which can store pre-compensated values for compensating the voltage-controlled crystal oscillator (VCXO) within the mobile unit.

It is one more object of the present invention to provide a method for compensating the voltage-controlled crystal oscillator (VCXO) of the mobile unit.

In one aspect of the present invention, an input voltage compensation method for voltage-controlled crystal oscillator (VCXO) within the mobile unit is aimed at regulating a predetermined transmission frequency for Tx burst and Rx burst between the mobile unit and base station. The method comprises the following steps. Firstly, defining a pre-compensated value according to a voltage drop of an auto frequency control (AFC) voltage. While proceeding signal transmission between the mobile unit and the base station under each output power level, a specific pre-compensated value is measured at a corresponding power level. Next is to proceed a compensating procedure upon the VCXO with the pre-compensated value. While transmitting Tx burst from the mobile unit to the base station, the frequency of Tx burst is regulated with respect to the frequency of Rx burst. Additionally, the foregoing steps of proceeding a compensating procedure further comprises a step of determining a corresponding pre-compensated value by judging the concurrent or present power level and another step of accessing the corresponding pre-compensated value from a data base, in which the data base is for storing the corresponding pre-compensated value according to each output power level.

In another aspect of the present invention, a method for establishing a database within a mobile unit can have pre-compensated values stored in the database so as to compensate the VCXO within the mobile unit. The method may comprise the following steps. Firstly is to define a pre-compensated range according to the voltage drop of AFC voltage while proceeding signal transmission between the mobile unit and the base station at different power levels. Next is to determine a compensation resolution by judging the AFC voltage and available bit numbers. Then, determining a pre-compensated value in accordance with the compensation resolution and the pre-compensated range is performed. Finally is to store the corresponding pre-compensated values to the database according to each output power level.

In a further aspect of the present invention, a design of a mobile unit is provided as follow. The mobile unit at least includes a database, a voltage-controlled crystal oscillator (VCXO), a digital signal processor (DSP) and a frequency synchronization circuit. The data base is responsible for storing corresponding pre-compensated values according to each output power level, wherein pre-compensated values are the voltage drops of the AFC voltage which are measured during proceeding signal transmission between the mobile unit and the base station at different power levels. The VCXO is for generating a first reference frequency of the base band frequency for Tx burst. The DSP is for accessing corresponding pre-compensated value according to individual power level and compensating the VCXO so as to generate a second reference frequency from the VCXO. It should be noted that the mobile unit further comprises a digital/analog converter (DAC) for converting the pre-compensated value to analog voltage signal and for compensating the VCXO. The frequency synchronization circuit is for synchronizing the second reference frequency to the frequency of Tx burst so that the frequency of Tx burst can be regulated with respect to the frequency of Rx burst from the base station.

### BRIEF DESCRIPTION OF THE DRAWINGS

The present invention will now be specified with reference to its preferred embodiment illustrated in the drawings, in which

FIG. 1 is a diagram illustrating communication between a mobile phone and a base station;

FIG. 2 is a block diagram for generating transmission frequency within a mobile phone according to a prior art;

FIG. 3 a block diagram for generating frequency of Tx burst within the mobile unit according to a preferred embodiment of the present invention;

FIG. 4 is a plot of measured voltage drop of auto frequency control (AFC) voltage while transmitting Tx burst in accordance with the preferred embodiment of FIG. 3; and

FIG. 5 is a table of the database of FIG. 3.

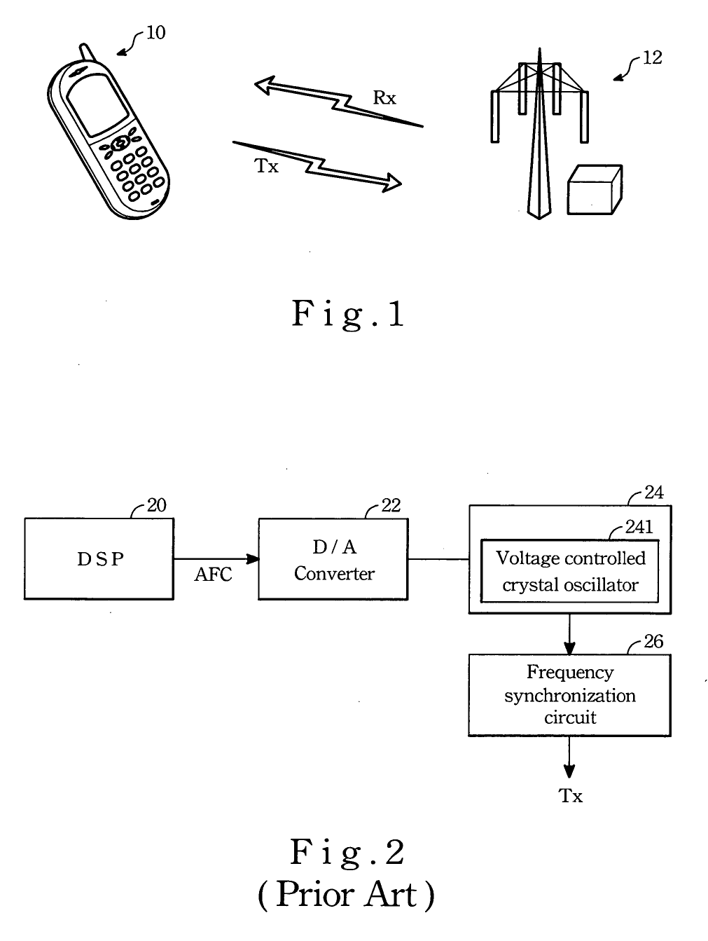

### DESCRIPTION OF THE PREFERRED EMBODIMENT

The invention disclosed herein is to provide a compensation method and a corresponding device within a mobile unit for compensating a voltage-controlled crystal oscillator with a voltage signal. The compensation method is provided by accessing a pre-compensated value form a data base to compensate the voltage-controlled crystal oscillator (VCXO) so that a frequency of Tx burst from the mobile phone can be regulated with respect to the predetermined frequency of Rx burst of the base station. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

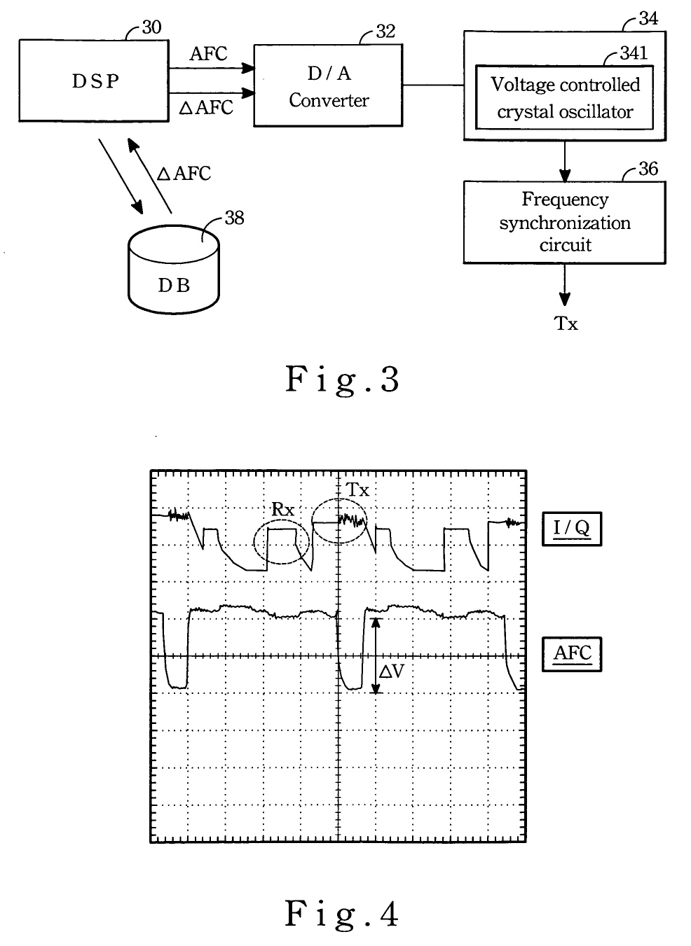

As shown in FIG. 3, a block diagram for generating frequencies of Tx burst within the mobile unit according to a preferred embodiment of the present invention is illustrated. The mobile unit at least includes a digital signal processor (DSP) 30, a digital/analog converter (DAC) 32, an oscillation circuit 34, a frequency synchronization circuit 36, and a database 38. The database 38 is for storing corresponding pre-compensated values according to each output power level, wherein the pre-compensated values can be voltage drops of auto frequency control (AFC) voltage which are measured during proceeding signal transmission between the mobile unit (a mobile phone in this preferred embodiment) and the base station at different power levels. The oscillation circuit 34 further includes a voltage-controlled crystal oscillator (VCXO) 341 for generating a base band frequency (also known as a first reference frequency) for Tx burst.

The digital signal processor (DSP) 30 is responsible for accessing a corresponding pre-compensated value according to each output power level and further for compensating VCXO 341 so as to generate a second reference frequency from the VCXO 341. It should be noted that the foregoing pre-compensated values are converted from digital units to analog voltage signals through the DAC 32 prior to compensate the VCXO 341. The frequency synchronization circuit 36 is for synchronizing the second reference frequency to the frequency of Tx burst so that the frequency of Tx burst can be regulated with the frequency of Rx burst from the base station.

In the preferred embodiment, a method for establishing the database 38 in which the pre-compensated values are stored is provided to compensate the VCXO 341. Firstly in this method, a pre-compensated range (ΔV) is defined according to the voltage drop of AFC voltage during proceeding signal transmission between the mobile unit and the base station at a specific output power level (such as L5 in GSM system).

Referring to FIG. 4, the ΔV event is occurred while transmitting the Tx burst, the power amplifier draws a lot of current from LDO (low-dropout regulators) and thus lowers the AFC voltage converted by the DAC 32. This voltage drop will directly affect the reference clock of the mobile unit and generate part of frequency errors.

Next in the method, a compensation resolution is determined by the AFC voltage and available bit numbers. In addition, the available bit number is defined by the DSP 30. In the preferred embodiment, for instance, we can set the available bit numbers to 13 bits ranged from −4096 to +4095, and the controllable AFC voltage can be ranged from 3 mV to 2.4V. The compensation resolution of the present invention can be calculated by the following equation (1):
(AFC voltage)/(available bit numbers)=compensation resolution (1)
Then, by applying the data mentioned above, the compensation resolution will be about 0.2926 mV. Next, the pre-compensated value (ΔAFC) can be decided by the compensation resolution and the pre-compensated range (ΔV). However, the pre-compensated value under the maximum output power level is known as the most widely range of the pre-compensated value. Afterward, the pre-compensated value can be calculated by equation (2):
ΔV/(the compensation resolution)=ΔAFC (2)

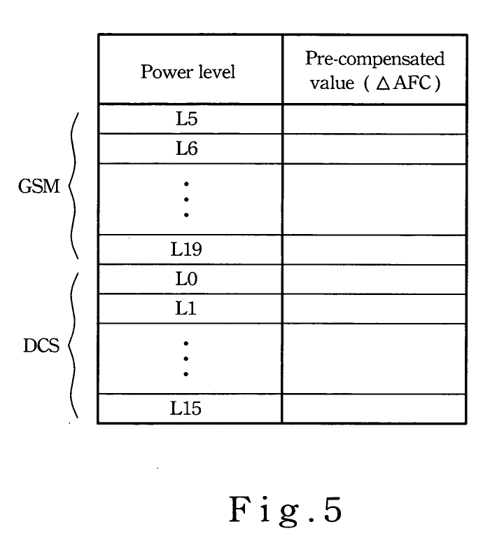

Subsequent is to convert the pre-compensated value (ΔAFC) and storing it to the data base 38 according to corresponding output power level. Next, the foregoing steps and storing the pre-compensated values in turn according to the individual output power levels (e.g. power level 5 to power level 19 for the GSM system and power level 0 to power level 15 for the DCS system) are repeated. As shown in FIG. 5, a table of the database 38 according to the preferred embodiment of the present invention is shown.

As described above, the method for compensating the VCXO 341 with voltage signals comprises the following steps. Firstly, define a pre-compensated value according to the voltage drop of the AFC voltage. While proceeding signal transmission between the mobile unit and the base station under each output power level, specific pre-compensated values are measured at corresponding power levels. Next, proceed a compensating procedure to the VCXO 341 with the pre-compensated value. While transmitting Tx burst from the mobile unit to the base station, the DSP 30 will access the corresponding pre-compensated value from the database 38 according to the specific output power level such that the frequency of Tx burst can be regulated with respect to the frequency of Rx burst.

In summary, the compensation method of the invention provides at least following advantages over the conventional techniques:

(1) The compensation method of the present invention is helpful for eliminating the frequency error and thus provides more effective reliable solutions.

(2) Based on the compensation method of the present invention and due to the database able to store corresponding pre-compensated value in accordance with each output power level during signal transmission, the mobile unit can access a determined value from the database so as to compensate the VCXO in a dynamic manner.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as will as other embodiments, are intended to be included within the scope of the appended claims. The invention is defined by the following claims, with equivalents of the claims to be included therein.

1. An compensation method for regulating an input voltage, the input voltage for inputting to a voltage-controlled crystal oscillator (VCXO) within a mobile unit and corresponding to a transmission frequency for Tx burst and Rx burst between the mobile unit and a base station, the method comprising steps of:
defining a pre-compensated value according to a voltage drop of an auto frequency control voltage while proceeding signal transmission between the mobile unit and the base station, wherein a plurality of pre-compensated values are defined in response to specific voltage drops;
compensating the input voltage with said pre-compensated value while transmitting the Tx burst from the mobile unit to the base station; and
generating the transmission frequency by the voltage-controlled crystal oscillator with the compensated input voltage.

2. The method of claim 1, wherein said step of defining the pre-compensated value further comprises a step of determining said pre-compensated value according to a present Tx power level of the mobile unit and accessing said pre-compensated value from a database.

3. The method of claim 2, wherein said database is for storing a plurality of pre-compensated values corresponding to individual Tx power levels, each Tx power level corresponding to a specific voltage drop.

4. The method of claim 3, wherein the maximum range of said pre-compensated value is dependent on the pre-compensated value of the maximum transmitting power level of said mobile unit.

5. The method of claim 1, wherein said pre-compensated value is a digital data.

6. The method of claim 1, wherein said mobile unit is a mobile phone.

7. The method of claim 6, wherein the power levels include level 5 to level 19 for a GSM system.

8. The method of claim 6, wherein the power levels include level 0 to level 15 for a DCS system.

9. A method for establishing a database within a mobile unit, a plurality of pre-compensated values are stored in said database so as to compensate a voltage-controlled crystal oscillator (VCXO) within said mobile unit, the method comprising steps of:
defining a pre-compensated range according to a voltage drop of an auto frequency control voltage while proceeding signal transmission between the mobile unit and a base station at different power levels;
determining a compensation resolution, wherein said compensation resolution is determined by the auto frequency control voltage and available bit numbers;
determining said pre-compensated values in accordance with said compensation resolution, said pre-compensated range and different power levels; and
storing said corresponding pre-compensated values to said database according to different power levels.

10. The method of claim 9, wherein said pre-compensated value is a digital data.

11. A mobile unit, comprising:
a database for storing a plurality of pre-compensated values according to different power levels, wherein said pre-compensated values are voltage drops of an auto frequency control voltage while proceeding signal transmission between the mobile unit and a base station at different power levels;
a voltage-controlled crystal oscillator for generating a first reference frequency of a base band frequency for Tx burst;
a digital signal processor for accessing the database according to a individual power level for getting a pre-compensated value to compensate said voltage-controlled crystal oscillator so as to generate a second reference frequency from said voltage-controlled crystal oscillator; and
a frequency synchronization circuit for synchronizing said second reference frequency to a frequency of Tx burst so that the frequency of Tx burst is regulated with respect to a frequency of Rx burst from the base station.

12. The mobile unit of claim 11, wherein said pre-compensated value is a digital data.

13. The mobile unit of claim 12, wherein said mobile unit further comprises a digital/analog converter for converting the pre-compensated value to an analog voltage signal and for compensating said voltage-controlled crystal oscillator.

14. The mobile unit of claim 11, wherein said mobile unit is a mobile phone.

15. The mobile unit of claim 14, wherein the power levels include level 5 to level 19 for a GSM system.

16. The mobile unit of claim 14, wherein the power level include level 0 to level 15 for a DCS system.
